(19) United States
(12) Patent Application Publication
(10) Pub. No.: US 2025/0237625 A1
(43) Pub. Date: Jul. 24, 2025

(54) ENHANCED SELECTIVITY MATERIAL FOR BIOFUEL SENSING INTERFACES

(71) Applicant: OHIO STATE INNOVATION FOUNDATION, Columbus, OH (US)

(72) Inventors: Jinghua Li, Columbus, OH (US); Tzu-Li Liu, Columbus, OH (US); Yizhen Jia, Columbus, OH (US)

(21) Appl. No.: 19/021,444

(22) Filed: Jan. 15, 2025

Related U.S. Application Data
(60) Provisional application No. 63/622,644, filed on Jan. 19, 2024.

(51) Int. Cl. G01N 27/327

(52) U.S. Cl. CPC G01N 27/3271

(57) ABSTRACT

Disclosed herein is a biofuel device comprising: an anode electrode configured to oxidize a target material; and a cathode electrode comprising a solid electrolyte; wherein the solid electrolyte comprises: a polymer matrix and a plurality of ionically conductive particles embedded within the polymer matrix. Also disclosed are methods of making the same.

### CROSS REFENCE TO RELATED APPLICATIONS

This application claims the benefit of U.S. Provisional Application No. 63/622,644, filed Jan. 19, 2024, the content of which is incorporated herein by reference in its entirety.

### STATEMENT OF GOVERNMENTAL SUPPORT

This invention was made with government support under Grant No. 2223387, awarded by the National Science Foundation. The government has certain rights in the invention.

### TECHNICAL FIELD

This application generally relates to materials that enhance the selectivity of biofuel cell interfaces.

### BACKGROUND

Biological fuel cells, also known as biofuel cells, have received much attention in past years. Herein, the term “biological fuel cell” or “biofuel cell” refers to an electrochemical cell having performance attributes that permit its use in a biological system. Biological fuel cells generate electrical energy using components found in biological systems, such as sugars, alcohols, carboxylic acids, carbohydrates, starches, cellulose, and oxygen.

Numerous biofuel cells have been described in the past fifty years. However, these cells continue to have challenges related to sensor accuracy that can be adversely affected by varying ionic species of the environment.

Thus, new biofuel configurations are needed. Especially are needed biofuel devices having stabilized the ionic strength and PH levels of the sensing interface. These and the other needs are addressed herein.

### SUMMARY

Disclosed herein is a biofuel device comprising: an anode electrode configured to oxidize a target material; and a cathode electrode comprising a solid electrolyte; wherein the solid electrolyte comprises: a polymer matrix and a plurality of ionically conductive particles embedded within the polymer matrix.

Also disclosed herein is a method comprising: providing a cathode electrode comprising a conductive layer; forming a solid electrolyte on the conductive layer; providing an anode electrode and forming the biofuel device of any one of examples disclosed herein.

Other systems, methods, features, and/or advantages will be or may become apparent to one with skill in the art upon examination of the following drawings and detailed description. It is intended that all such additional systems, methods, features, and/or advantages be included within this description and be protected by the accompanying claims.

### BRIEF DESCRIPTION OF DRAWINGS

FIG. 1 shows an exemplary schematic of a common biofuel cell configuration.

FIG. 2 shows an exemplary schematic of an exemplary biofuel cell configuration according to one aspect of this disclosure.

FIG. 3 shows a comparative analysis of the data obtained with an exemplary biofuel configuration according to one aspect of this disclosure.

### DETAILED DESCRIPTION

It is appreciated that certain features of the disclosure, which are, for clarity, described in the context of separate aspects, can also be provided in combination with a single aspect. Conversely, various features of the disclosure, which are, for brevity, described in the context of a single aspect, can also be provided separately or in any suitable sub-combination. Unless defined otherwise, all technical and scientific terms used herein have the same meaning as commonly understood by one of ordinary skill in the art. Methods and materials similar or equivalent to those described herein can be used in the practice or

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination with a single aspect. Conversely, various features of the disclosure, which are, for brevity, described in the context of a single aspect, can also be provided separately or in any suitable sub-combination.

As used in the description and the appended claims, the singular forms “a,” “an,” and “the” include plural referents unless the context clearly dictates otherwise. Thus, for example, a reference to “a salt” includes not only one but also two or more such salts, and a reference to “a polymer” includes not only one but also two or more such polymers and the like.

Still further, as used herein, the term “at least one” encompasses one or more of the specified elements. That is, if two of a particular element are present, one of these elements is also present, and thus “an” element is present.

Throughout the description and claims of this specification, the word “comprise” and other forms of the word, such as “comprising” and “comprises,” are open, non-limiting terms and mean “including but not limited to,” and are not intended to exclude, for example, other additives, segments, integers, or steps. Furthermore, it is to be understood that the terms “comprise,” “comprising,” and “comprises” as they relate to various aspects, elements, and features of the disclosed invention also include the more limited aspects of “consisting essentially of” and “consisting of.”

For the terms “for example” and “such as,” and grammatical equivalences thereof, the phrase “and without limitation” is understood to follow unless explicitly stated otherwise. It is further understood that these phrases are used for explanatory purposes only. It is further understood that the term “exemplary,” as used herein, means “an example of” and is not intended to convey an indication of a preferred or ideal aspect.

The expressions “ambient temperature” and “room temperature” as used herein are understood in the art and refer generally to a temperature from about 20° C. to about 35° C.

All disclosed values also include values that fall within ±10% variation from the disclosed value unless otherwise indicated or inferred. In other words, if a range of 1 to 10 is disclosed, then a range of about 1 to about 10 is disclosed. In such aspects, it is understood that the amount or value in question can be the exact value or a value that provides equivalent results or effects as recited in the claims or taught herein. That is, amounts, sizes, formulations, parameters, and other quantities and characteristics include both exact values but also approximate, larger or smaller values as desired, reflecting tolerances, conversion factors, rounding, measurement error, and the like, and other factors known to those of skill in the art such that equivalent results or effects are obtained. In some circumstances, the value that provides equivalent results or effects cannot be reasonably determined. In general, an amount, size, formulation, parameter, or other quantity or characteristic is “about,” “approximate,” or “at or about,” whether or not expressly stated to be such. Where “about,” “approximate,” or “at or about” is used before a quantitative value, the parameter also includes the specific quantitative value itself unless expressly stated otherwise.

When a range is expressed, a further aspect includes from the one particular value and to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘x, y, z, or less’ and should be interpreted to include the specific ranges of ‘x,’ ‘y,’ ‘z,’ ‘about x,’ ‘about y,’ and ‘about z’ as well as the ranges of ‘less than x,’ ‘less than y, or ‘less than z,’ or ‘less than about x,’ ‘less than about y, and ‘less than about z.’ Likewise, the phrase’ x, y, z, or greater’ should be interpreted to include the specific ranges of ‘x,’ ‘y,’ ‘z,’ ‘about x,’ ‘about y,’ and ‘about z’ as well as the ranges of ‘greater than x,’ greater than y,’ ‘greater than z,’ or ‘greater than about x,’ greater than about y,’ ‘greater than about z.’ In addition, the phrase” ‘x’ to ‘y’,” where ‘x’ and y′ are numerical values, also includes “about x’ to about y’.”

Such a range format is used for convenience and brevity and, thus, should be interpreted flexibly to include not only the numerical values explicitly recited as the limits of the range but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5% but also include individual values (e.g., 1%, 2%, 3%, and 4%) and the sub-ranges (e.g., 0.5% to 1.1%; 5% to 2.4%; 0.5% to 3.2%, and 0.5% to 4.4%, and other possible sub-ranges) within the indicated range. In still further aspects, when the specific values are disclosed between two end values, it is understood that these end values can also be included.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

In still further aspects, when the specific values are disclosed between two end values, it is understood that these end values can also be included.

In still further aspects, when the range is given, and exemplary values are provided, it is understood that any ranges can be formed between any exemplary values within the broadest range. For example, if individual numbers 1, 2, 3, 4, 5, 6, 7, etc. are disclosed, then the ranges 1-7, 2-7, 3-7, 4-7, 5-7, 6-7, 1-6, 1-5, 1-4, 1-3, 1-2, 2-6, 2-5, etc. are also disclosed.

As used herein, the terms “optional” or “optionally” mean that the subsequently described event or circumstance may or may not occur and that the description includes instances where said event or circumstance occurs and instances where it does not.

In still further aspects, when the specific values are disclosed between two end values, it is understood that these end values can also be included.

As used herein, the term “composition” is intended to encompass a product comprising the specified ingredients in the specified amounts, as well as any product that results, directly or indirectly, from a combination of the specified ingredients in the specified amounts.

References in the specification and concluding claims to parts by weight of a particular element or component in a composition denote the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 90%, at least about 95%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially,” in, for example, the context “substantially identical reference composition,” or “substantially identical reference article,” or “substantially identical reference electrochemical cell,” refers to a reference composition, article, or an electrochemical cell comprising substantially identical components and wherein an inventive component is substituted with a common in the art component.

The term “anode” refers to an electrode of an electrochemical cell at which oxidation occurs.

The term “cathode” refers to an electrode of an electrochemical cell at which reduction occurs.

While aspects of the present invention can be described and claimed in a particular statutory class, such as the system statutory class, this is for convenience only, and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Device

Disclosed herein is a biofuel device comprising: an anode electrode configured to oxidize a sensing target; and a cathode electrode comprising a solid electrolyte; wherein the solid electrolyte comprises: a polymer matrix and a plurality of ionically conductive particles embedded within the polymer matrix.

The disclosed herein biofuel devices exhibit improved selectivity when compared with the conventional biofuel devices. The disclosed biofuel devices address a prevalent issue in traditional biofuel cell interfaces where sensor accuracy is adversely affected by varying ionic species, for example, in variation in ionic species in the surrounding environment.

In certain aspects, the cathode material disclosed herein comprises a solid electrolyte comprising a polymer matrix and a plurality of ionically conductive particles that are embedded with this matrix.

In certain aspects, the solid electrolyte can have a thickness of 1 to 30 microns, including exemplary values of 1, 2, 5, 8, 10, 12, 15, 18, 20, 22, 25, and 28 microns. In yet still further aspects, the solid electrolyte can have a thickness value that falls between any two foregoing values, or falls within a range that is formed by any two foregoing values. For example, and without limitations, the solid electrolyte can have a thickness of 1-20 microns, 1-18 microns, 1-15 microns, 1-12 microns, 1-10 microns, 1-8 microns, 1-5 microns, 2-20 microns, 5-20 microns, 8-20 microns, 10-20 microns, and so on.

Without wishing to be bound by any theory, it is understood that in certain aspects, the functionality of the solid electrolyte is dependent on its pKa, which helps to stabilize the surrounding environment.

In still further aspects, the polymer matrix comprises one or more of polyvinyl butyral, polyvinyl chloride, polycaprolactone, polyethylene terephthalate, perfluorosulfonic acid-based polymer (Nafion™), or any combination thereof.

In still further aspects, the plurality of ionically conductive particles can comprise inorganic and/or organic materials. In certain aspects, the inorganic and/or organic materials can comprise inorganic and/or organic salts. Yet in still further aspects, the organic materials can comprise acids and bases that can be present as particles.

In still further aspects, the plurality of ionically conductive particles behave as a buffering material.

It is understood and without wishing to be bound by any theory, the disclosed herein compositions are configured to stabilize both the ionic strength and ph levels at the sensing interface, which is a significant enhancement in the realm of biosensor technology.

In still further aspects, and as mentioned above, the biofuel device exhibits a response that is not affected by fluctuation in an ionic condition of a sensing environment. Yet in still further aspects, the biofuel device exhibits a response that is not affected by fluctuation in a pH of a sensing environment.

In still further aspects, the solid electrolyte has buffering properties due to the presence of the ionically conductive particles. It is understood (and without wishing to be bound by any theory) that this buffer layer effectively improves the sensor's performance by substantially reducing its cross sensitivity to changes in ionic strength. For example, a substantially identical reference biofuel device that does not comprise the claimed solid electrolyte, was found to exhibit a change of approximately 8 mV/mM in response to variations in ionic strength of the surrounding environment. However, the addition of the solid electrolyte claimed herein resulted in dramatical decrease of the interference, resulting in a much lower fluctuation in the sensing values regardless of the change in the ionic strength or pH of the surrounding environment. In still further aspects, the fluctuation in the ionic strength or pH of the surrounding environment results in a fluctuation that is less than 5%, less than 4.5%, less than 4%, less than 3.5%, less than 3%, less than 2.5%, less than 2% of the fluctuation in the ionic strength of pH of the surrounding environment that is observed in the absence of the claimed solid electrolyte.

In certain aspects, a plurality of ionically conductive particles embedded within the polymer matrix can be in a concentration from 1 to 10 weight percent (wt %), including exemplary values of 2, 3, 4, 5, 6, 7, 8, and 9 wt %. In still further aspects, the plurality of ionically conductive particles can present in an amount of 1-10 wt %, 1-9 wt %, 1-8 wt %, 1-6 wt %, 1-5 wt %, 1-3 wt %, 2-10 wt %, 5-10 wt %, 8-10 wt %, 2-5 wt %, 3-8 wt %, and so on.

In still further aspects, the plurality of ionically conductive particles comprise halogen salts of alkali and alkaline-earth metals, phosphate salts of alkali and alkaline-earth metals, acetate salts of alkali and alkaline-earth metals, carbonate salts of alkali and alkaline-earth metals, borate salts of alkali and alkaline-earth metals, polyacrylate salts of alkali and alkaline-earth metals, borate salts of alkali and alkaline-earth metals, or any combination thereof. Yet in still further aspects, the plurality of ionically conductive particles can comprise tris base, citric acid, acetic acid, ammonium acetate, ammonium phosphate buffer, carbonic acid, bicarbonate, Deoxyribonucleic acid (DNA), polyacrylic acid (PAA), polyethyleneimine (PEI), polystyrene sulfonate (PSS), polydiallydimethylammonium chloride (PolyDADMAC), chitosan, alginate, heparin, poly(methacrylic acid) (PMMA), carrageenan, xanthan gum, polyvinyl sulfate, or any combination thereof.

In yet still further aspects, the plurality of ionically conductive particles can comprise halogen salts of alkali and alkaline-earth metals, phosphate salts of alkali and alkaline-earth metals, acetate salts of alkali and alkaline-earth metals, carbonate salts of alkali and alkaline-earth metals, borate salts of alkali and alkaline-earth metals, polyacrylate salts of alkali and alkaline-earth metals, borate salts of alkali and alkaline-earth metals, tris base, citric acid, acetic acid, ammonium acetate, ammonium phosphate buffer, carbonic acid, bicarbonate, Deoxyribonucleic acid (DNA), polyacrylic acid (PAA), polyethyleneimine (PEI), polystyrene sulfonate (PSS), polydiallydimethylammonium chloride (PolyDADMAC), chitosan, alginate, heparin, poly(methacrylic acid) (PMMA), carrageenan, xanthan gum, polyvinyl sulfate, or any combination thereof.

In yet still further aspects, a variety of buffer salt can be utilized as long as it can stabilize the local pH and ionic strength within the sensor's environment. It includes but not limited to sodium phosphate Monobasic (NaH₂PO₄), sodium phosphate dibasic (Na₂HPO₄), potassium phosphate Monobasic (KH₂PO₄), potassium phosphate dibasic (K₂HPO₄), sodium acetate (CH₃COONa), sodium bicarbonate (NaHCO₃), sodium borate (Na₂B₄O₇), magnesium chloride (MgCl₂), sodium polyacrylate or combinations thereof.

In still further aspects, if the particles are present as salt, the salt becomes saturated in the local environment of the material, indicating that the maximum amount of salt has been dissolved within the given environment.

In still further aspects, the plurality of ionically conductive particles has an average size of about 0.05 μm to about 15 μm, 0.1 μm to about 15 μm, 0.5 μm to about 15 μm, 0.8 μm to about 15 μm, 1 μm to about 15 μm, 3 μm to about 15 μm, 5 μm to about 15 μm, 0.05 μm to about 10 μm, 0.05 μm to about 5 μm, 0.05 μm to about 3 μm, 0.05 μm to about 1 μm, 0.05 μm to about 0.5 μm, 0.5 μm to about 5 μm, q μm to about 3 μm, and so on.

In still further aspects, the plurality of ionically conductive particles are spatially distributed within the polymer matrix.

In certain aspects, the cathode electrode further comprises a conductive layer comprising a metal, carbon, or any combination thereof. Yet in still further aspects, the conductive layer comprises Pt/C. Yet in still further aspects, the cathode electrode further comprises Nafion®.

In some aspects, the anode comprises a conductive layer, a mediator layer disposed on the conductive layer, and a catalyst layer disposed on the mediator layer. In yet still further aspects, the materials present in the anode are designed to provide anodes with high conductivity and high surface area.

In certain aspects, the conductive layer comprises a metal, graphene, carbon nanotubes, conductive polymers, metal-organic frameworks, activated carbon, porous silicon, titanium carbide, porous god, nickel fam, bismuth vanadate, or a combination thereof.

In certain aspects, the catalyst layer can comprise an immobilizer. In other aspects, the catalyst layer can comprise a crosslinker. For example, glutaraldehyde can function as a crosslinker, forming a hydrogel network. Immobilizers can comprise Nafion, BSA, PET (Polyethylene Terephthalate), PVB (Polyvinyl Butyral), PVC (polyvinyl chloride), PCL (polycaprolactone), chitosan, polyvinyl alcohol (PVA), polyethylene glycol (PEG), polyacrylamide.

In still further aspects, the catalyst layer is a biorecognition material. In still further aspects, the catalyst layer comprises an enzyme glutamate oxidase, enzymes, inorganic catalyst, or any combination thereof.

In certain aspects, the mediator layer is configured to facilitate electron transfer between the catalyst layer and the conductive layer and comprises one or more of tetrathiafulvalene (TTF), ferrocene, and its derivatives; methylene blue; quinones (e.g., anthraquinone, benzoquinone); ruthenium complexes; Prussian blue; cobaltocenium/cobaltocene; thionine; ferrocyanide/ferricyanide; N,N,N′,N′-tetramethyl-p-phenylenediamine (TMPD); 2,6-dichlorophenolindophenol (DCIP), or any combination thereof.

In still further aspects, the biofuel device disclosed herein is a health monitor. For example, and without limitations, the biofuel device disclosed herein can be designed for glucose detection. In such exemplary and unlimiting aspects, the anode can comprise enzymes, TTF, BSA, and Nafion®, while cathode can further comprise PtC and Nafion®. The application of this innovative solid electrolyte material on the cathode successfully mitigates the impacts of ion fluctuations and pH changes, ensuring enhanced accuracy in sensing applications. It is understood that other substances related to health monitoring can be also measured by the disclosed herein devices.

In yet still further aspects, the biofuel device can be an energy generating device, a sensor, or a combination thereof.

In yet still further aspects, the biofuel device is an environmental monitor (e.g., water quality and assessing environmental pollutants).

Also disclosed herein are methods of making such devices. In such aspects, the methods comprise providing a cathode electrode comprising a conductive layer; forming a solid electrolyte on the conductive layer; providing an anode electrode and forming the biofuel device. In still further aspects, any of the disclosed above solid electrolytes can be formed. In still further aspects, the step of forming the solid electrolyte can comprise drop-casting, spin-casting, immersing, spray-casting, extrusion, doctor blading dip, coating, screen printing, hot pressing, 3D printing, vapor deposition, layer-by-layer assembly sintering, sol-gel process, electrospinning, or any combination thereof of a polymer matrix comprising a plurality of particles embedded within the polymer matrix.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure.

### Example 1

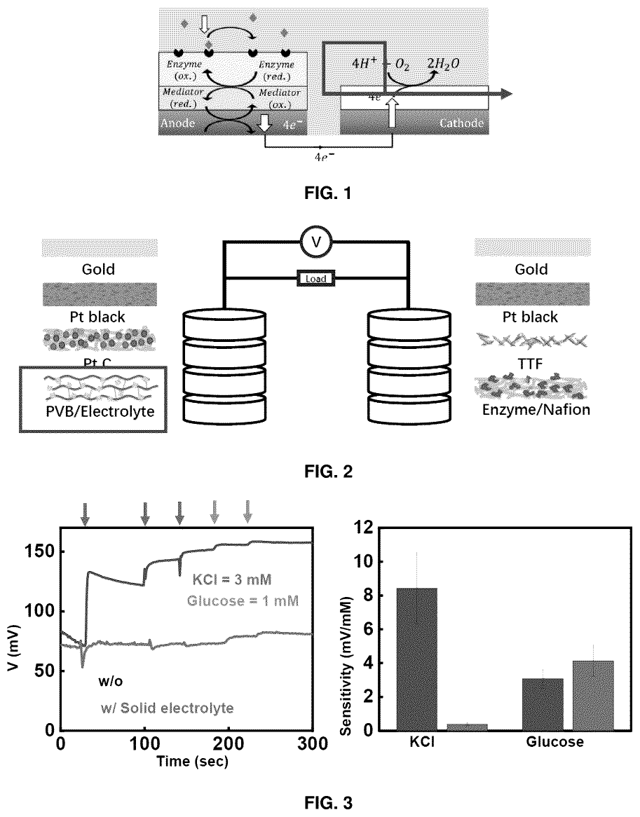

FIG. 1 describes a conventional biofuel device. In such a device the sensing target is oxidizes generating electrons as a part of the sensor's signal, while oxygen is reduced on the cathode to form water. It is understood that one of the issue with the conventional devices is sensitivity of the reactions occurring on the cathode to the ionic strength and/or pH of the surrounding environment.

### Example 2

The exemplary device is shown in FIGS. 2 and 3. In this example, a PVB serves as a polymer network, effectively holding the plurality of ionically conductive particles in place. Importantly, this approach is adaptable, allowing for the substitution of PVB with other polymers such as PVC, PCL, PET, Nafion, etc., depending on the application's specific needs. These polymers are designed to encapsulate buffer salt microparticles.

FIG. 3 shows an exemplary and comparative results for measuring glucose levels and the response to KCl. It can be seen that the devices with the solid electrolytes disclosed herein show significant reduction in KCl response that demonstrates the materials effectiveness in ion interference mitigation.

The plurality of particles play a role in acting as an electrolyte, stabilizing the local pH and ionic strength within the sensor's environment. This stabilization is key to enhancing the sensor's accuracy and reliability.

Without wishing to be bound by any theory it is understood that the immobilization of the particles disclosed herein ensures a consistent spatial distribution of the salt (particles). The solubility of these salts mitigates the effect of fluctuating environmental conditions, such as pH and ionic strength.

Moreover, the disclosed herein technique is versatile in terms of the buffer salts that can be utilized. Alongside sodium chloride (NaCl), other salts can be employed, including sodium phosphate monobasic (NaH₂PO₄), sodium phosphate dibasic (Na₂HPO₄), potassium phosphate monobasic (KH₂PO₄), potassium phosphate dibasic (K₂HPO₄), sodium acetate (CH₃COONa), sodium bicarbonate (NaHCO₃), tris base (C₄H₁₁NO₃), sodium borate (Na₂B₄O₇), citric acid (C₆H₈O₇), magnesium chloride (MgCl₂), etc. In certain aspects, the plurality of particles are sized between 1-10 μm.

The disclosed herein solid electrolytes can be tailored to the desired sensing environment to enhance their adaptability. Without wishing to be bound by any theory, it is understood that this adaptability allows the material to maintain its stabilizing properties across arrange of sensor applications

### EXEMPLARY ASPECTS

Example 1. A biofuel device comprising: an anode electrode configured to oxidize a target material; and a cathode electrode comprising a solid electrolyte; wherein the solid electrolyte comprises: a polymer matrix and a plurality of ionically conductive particles embedded within the polymer matrix.

Example 2. The biofuel device of any one of examples herein, particularly Example 1, wherein the biofuel device exhibits a response that is not affected by fluctuation in an ionic condition of a sensing environment.

Example 3. The biofuel device of any one of examples herein, particularly Example 1 or 2, wherein the biofuel device exhibits a response that is not affected by fluctuation in a pH of a sensing environment.

Example 4. The biofuel device of any one of preceding Examples, wherein the polymer matrix comprises one or more of polyvinyl butyral, polyvinyl chloride, polycaprolactone, polyethylene terephthalate, perfluorosulfonic acid-based polymer (Nafion™), or any combination thereof.

Example 5. The biofuel device of any one of preceding Examples, wherein the plurality of ionically conductive particles behave as a buffering material.

Example 6. The biofuel device of any one of preceding Examples, wherein the plurality of ionically conductive particles comprise inorganic and/or organic salts.

Example 7. The biofuel device of any one of preceding Examples, wherein the plurality of ionically conductive particles comprise halogen salts of alkali and alkaline-earth metals, phosphate salts of alkali and alkaline-earth metals, acetate salts of alkali and alkaline-earth metals, carbonate salts of alkali and alkaline-earth metals, borate salts of alkali and alkaline-earth metals, polyacrylate salts of alkali and alkaline-earth metals, borate salts of alkali and alkaline-earth metals, or any combination thereof.

Example 8. The biofuel device of any one of preceding Examples, wherein the plurality of ionically conductive particles comprise tris base, citric acid, acetic acid, ammonium acetate, ammonium phosphate buffer, carbonic acid, bicarbonate, Deoxyribonucleic acid (DNA), polyacrylic acid (PAA), polyethyleneimine (PEI), polystyrene sulfonate (PSS), polydiallydimethylammonium chloride (PolyDADMAC), chitosan, alginate, heparin, poly(methacrylic acid) (PMMA), carrageenan, xanthan gum, polyvinyl sulfate, or any combination thereof.

Example 9. The biofuel device of any one of preceding Examples, wherein the plurality of ionically conductive particles has an average size of about 0.5 μm to about 15 μm.

Example 10. The biofuel device of any one of preceding Examples, wherein the cathode electrode further comprises a conductive layer comprising a metal, carbon, or any combination thereof.

Example 11. The biofuel device of any one of examples herein, particularly Example 10, wherein the conductive layer comprises Pt/C.

Example 12. The biofuel device of any one of preceding Examples, wherein the cathode electrode further comprises Nafion®.

Example 13. The biofuel device of any one of preceding Examples, wherein the anode comprises a conductive layer, a mediator layer disposed on the conductive layer, and a catalyst layer disposed on the mediator layer.

Example 14. The biofuel device of any one of examples herein, particularly Example 13, wherein the conductive layer comprises a metal, graphene, carbon nanotubes, conductive polymers, metal-organic frameworks, activated carbon, porous silicon, titanium carbide, porous god, nickel fam, bismuth vanadate, or a combination thereof.

Example 15. The biofuel device any one of examples herein, particularly Examples 13 or 14, wherein the mediator layer is configured to facilitate electron transfer between the catalyst layer and the conductive layer and comprises one or more of tetrathiafulvalene (TTF), ferrocene, and its derivatives; methylene blue; quinones (e.g., anthraquinone, benzoquinone); ruthenium complexes; Prussian blue; cobaltocenium/cobaltocene; thionine; ferrocyanide/ferricyanide; N,N,N′, N′-tetramethyl-p-phenylenediamine (TMPD); 2,6-dichlorophenolindophenol (DCIP), or any combination thereof.

Example 16. The biofuel device of any one of any one of examples herein, particularly Examples 13-15, wherein the catalyst layer is a biorecognition material.

Example 17. The biofuel device of any one of any one of examples herein, particularly Examples 13-16, wherein the catalyst layer comprises an enzyme glutamate oxidase, enzymes, inorganic catalyst, or any combination thereof.

Example 18. The biofuel device of claim of any one of examples herein, particularly Examples 13-17, wherein the catalyst layer comprises an immobilizer.

Example 19. The biofuel device of any one of preceding Examples wherein the plurality of particles are spatially distributed within the polymer matrix.

Example 20. The biofuel device of any one of preceding Examples, wherein the biofuel device is a health monitor (e.g., records glucose).

Example 21. The biofuel device of any one of preceding Examples, wherein the biofuel device is an energy generating device, a sensor, or a combination thereof.

Example 22. The biofuel device of any one of preceding Examples, wherein the biofuel device is an environmental monitor (e.g., water quality and assessing environmental pollutants).

Example 23. A method comprising: providing a cathode electrode comprising a conductive layer; forming a solid electrolyte on the conductive layer; providing an anode electrode and forming the biofuel device of any one of preceding Examples herein, particularly Examples 1-22.

Example 24. The method of any one of examples herein, particularly Example 23, wherein the step of forming the solid electrolyte comprises drop-casting, spin-casting, immersing, spray-casting, extrusion, doctor blading dip, coating, screen printing, hot pressing, 3D printing, vapor deposition, layer-by-layer assembly sintering, sol-gel process, electrospinning, or any combination thereof of a polymer matrix comprising a plurality of particles embedded within the polymer matrix.

What is claimed is:

1. A biofuel device comprising:
an anode electrode configured to oxidize a target material; and
a cathode electrode comprising a solid electrolyte; wherein the solid electrolyte comprises:
a polymer matrix and
a plurality of ionically conductive particles embedded within the polymer matrix.

2. The biofuel device of claim 1, wherein the biofuel device exhibits a response that is not affected by fluctuation in an ionic condition of a sensing environment and/or wherein the biofuel device exhibits a response that is not affected by fluctuation in a pH of a sensing environment.

3. The biofuel device of claim 1, wherein the polymer matrix comprises one or more of polyvinyl butyral, polyvinyl chloride, polycaprolactone, polyethylene terephthalate, perfluorosulfonic acid-based polymer (Nafion™), or any combination thereof.

4. The biofuel device of claim 1, wherein the plurality of ionically conductive particles behave as a buffering material.

5. The biofuel device of claim 1, wherein the plurality of ionically conductive particles comprise halogen salts of alkali and alkaline-earth metals, phosphate salts of alkali and alkaline-earth metals, acetate salts of alkali and alkaline-earth metals, carbonate salts of alkali and alkaline-earth metals, borate salts of alkali and alkaline-earth metals, polyacrylate salts of alkali and alkaline-earth metals, borate salts of alkali and alkaline-earth metals, or any combination thereof, and/or
wherein the plurality of ionically conductive particles comprise tris base, citric acid, acetic acid, ammonium acetate, ammonium phosphate buffer, carbonic acid, bicarbonate, Deoxyribonucleic acid (DNA), polyacrylic acid (PAA), polyethyleneimine (PEI), polystyrene sulfonate (PSS), polydiallydimethylammonium chloride (PolyDADMAC), chitosan, alginate, heparin, poly(methacrylic acid) (PMMA), carrageenan, xanthan gum, polyvinyl sulfate, or any combination thereof.

6. The biofuel device of claim 1, wherein the plurality of ionically conductive particles has an average size of about 0.5 μm to about 15 μm.

7. The biofuel device of claim 1, wherein the cathode electrode further comprises a conductive layer comprising a metal, carbon, or any combination thereof.

8. The biofuel device of claim 7, wherein the conductive layer comprises Pt/C.

9. The biofuel device of claim 1, wherein the cathode electrode further comprises Nafion™

10. The biofuel device of claim 1, wherein the anode comprises a conductive layer, a mediator layer disposed on the conductive layer, and a catalyst layer disposed on the mediator layer.

11. The biofuel device of claim 10, wherein the conductive layer comprises a metal, graphene, carbon nanotubes, conductive polymers, metal-organic frameworks, activated carbon, porous silicon, titanium carbide, porous god, nickel fam, bismuth vanadate, or a combination thereof.

12. The biofuel device claims 10, wherein the mediator layer is configured to facilitate electron transfer between the catalyst layer and the conductive layer and comprises one or more of tetrathiafulvalene (TTF), ferrocene and its derivatives; methylene blue; quinones; ruthenium complexes; Prussian blue; cobaltocenium/cobaltocene; thionine; ferrocyanide/ferricyanide; N,N,N′,N′-tetramethyl-p-phenylenediamine (TMPD); 2,6-dichlorophenolindophenol (DCIP), or any combination thereof.

13. The biofuel device of claim 10, wherein the catalyst layer is a biorecognition material and comprises an enzyme glutamate oxidase, enzymes, inorganic catalyst, or any combination thereof.

14. The biofuel device of claim 10, wherein the catalyst layer comprises an immobilizer.

15. The biofuel device of claim 1 wherein the plurality of ionically conductive particles are spatially distributed within the polymer matrix.

16. The biofuel device of claim 1, wherein the biofuel device is a health monitor.

17. The biofuel device of claim 1, wherein the biofuel device is an energy generating device, a sensor, or a combination thereof.

18. The biofuel device of claim 1, wherein the biofuel device is an environmental monitor.

19. A method comprising:
providing a cathode electrode comprising a conductive layer;
forming a solid electrolyte on the conductive layer;
providing an anode electrode and
forming the biofuel device of claim 1.

20. The method of claim 19, wherein the step of forming the solid electrolyte comprises drop-casting, spin-casting, immersing, spray-casting, extrusion, doctor blading dip, coating, screen printing, hot pressing, 3D printing, vapor deposition, layer-by-layer assembly sintering, sol-gel process, electrospinning, or any combination thereof of a polymer matrix comprising a plurality of particles embedded within the polymer matrix.
